(19) United States
(12) Patent Application Publication
(10) Pub. No.: US 2009/0010648 A1
(43) Pub. Date: Jan. 8, 2009

(54) Methods and apparatus for upgrading passive optical networks

(75) Inventor: Muneer Zuhdi, Plano, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Bedford, Inc., Naperville, IL (US)

(21) Appl. No.: 11/824,661

(22) Filed: Jul. 2, 2007

(51) Int. Cl. H04B 10/20

(52) U.S. Cl. 398/58

(57) ABSTRACT

An optical network system can be used to update legacy passive optical networks by adding an optical transmitter, blocking filter, and/or pluggable or unpluggable optics. In one embodiment, an optical network system, including several optical transmitters and receivers, multiplexers, demultiplexers, erbium-doped fiber amplifier, and blocking filter, may be employed. The additional transmitter increases available bandwidth, while the blocking filter allows existing customers' service(s) to not be impacted. Another embodiment uses pluggable or unpluggable optics, instead of the aforementioned blocking filter, to receive and modulate optical signals to transmit services to end users. In one embodiment, an optical network system can be employed that allows for simultaneous upgrading of the system and providing of legacy services, while allowing for the of removal existing optical network components over time.

### BACKGROUND OF THE INVENTION

Passive optical networks are currently used in telecommunications to provide services to end users. Example services include telephone, cable television, and the Internet. Passive optical networks, as used in current practice, typically include a service provider network, optical line terminal, multiplexer/demultiplexer, optical network unit(s), and end user equipment connected via an architecture of optical fiber. Implementation of the currently used passive optical network has been costly and is widely used.

### SUMMARY OF THE INVENTION

An example embodiment of the invention provides a method, or corresponding apparatus, of upgrading existing optical networks. The method includes adding a supplemental optical communications band, normally used in optical transport networks to carry identical forms of data traffic as carried in other optical communications bands, to at least a subset of multiple existing optical access networks having at least one existing communications band. Over time, a radio frequency video overlay is removed from at least one of the existing optical communications bands in a subset of the multiple existing optical access networks. Multi-cast channels may be applied to the supplemental optical communications bands to carry forms of data traffic previously carried by the radio frequency overlay.

Another example embodiment of the invention provides an optical receiver. The optical receiver includes a filter configured (i) to reflect a first optical signal traveling in a forward direction along a first optical path onto a second optical path and (ii) to pass a second optical signal traveling in a forward direction along the first optical path to a third optical path and, in a reverse direction, from the third optical path to the first optical path.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic diagram of network components of an example Gigabit Passive Optical Network (GPON) with video overlay as configured under current practice in which embodiments of the invention may be employed.

FIG. 2A is a schematic representation of network components of an example gigabit passive optical network with video overlay that includes an upgrade in accordance with example embodiments of the present invention.

FIG. 2B is a first of two flow diagrams illustrating upgrading existing optical networks in accordance with example embodiments of the present invention.

FIG. 2C is a second of two flow diagrams illustrating upgrading existing optical networks in accordance with example embodiments of the present invention.

FIG. 3 is a graphical representation of an optical design of an example quadplexer in accordance with an embodiment of the present invention.

FIG. 4 is a network schematic diagram of network components of an example wavelength division multiplexing passive optical network with video overlay that supports a cost-effective transparent upgrade in accordance with an example embodiment of the present invention.

FIG. 5 is a graphical representation of an integrated reflective semiconductor optical amplifier (RSOA)-based diplexer that may be used in accordance with an example embodiment of the invention.

### DETAILED DESCRIPTION OF THE INVENTION

A description of example embodiments of the invention follows.

In current practice, Gigabit Passive Optical Network (GPON) deployments have an optical line terminal (OLT) communicating with multiple optical network terminals (ONTs) with, for example, 2.4 Gbps downstream and 1.2 Gbps upstream links. Optical loss that can be tolerated in some networks is, for example, 28 dB bidirectionally.

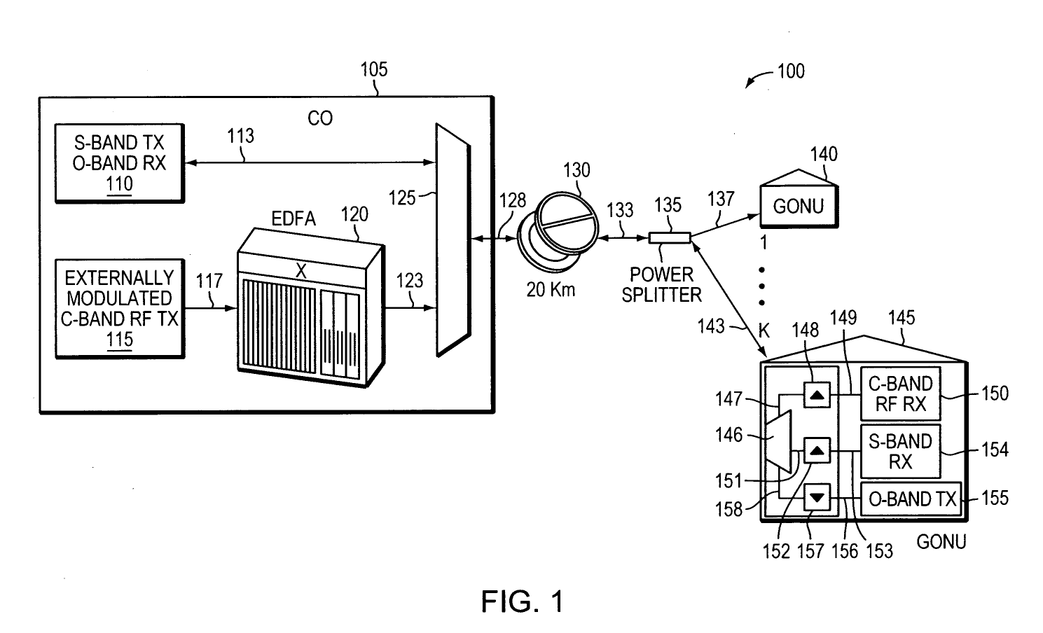

FIG. 1 shows a central office (CO) 105 with OLT equipment that has an S-band transmitter and O-band receiver. A video signal may be overlaid through the use of an externally-modulated C-Band radio frequency transmitter (EMCT) 115, an Erbium-Doped Fiber Amplifier (EDFA) 120 to boost the optical power, and a Wavelength Division Multiplexer (WDM) to combine the video signal with the OLT signal. A GPON Optical Network Unit (ONU) (GONU) separates the two downstream signals and isolates them from the transmitter O-Band signal.

Continuing to refer to FIG. 1, a subsystem 110 includes an S-Band transmitter (S-Band TX), which transmits optical wavelengths at approximately 1490 nm, and an O-Band receiver (O-Band RX), which receives optical wavelengths at approximately 1310 nm. The CO 105 may also include a coarse multiplexer 125. Optical paths and connections represented herein may be optical fibers or, in some embodiments, free space optical paths and span between corresponding optical communications components. Additionally, multiplexers and demultiplexers represented herein may employ arrayed waveguide gratings or other forms of optical components understood in the art to support multiplexing and demultiplexing operations.

The subsystem 110 with the S-Band TX and O-Band RX may be connected via an optical path 113 to the multiplexer 125. The EMCT 115 may be connected via an optical path 117 to the EDFA 120, which may then be connected via an optical path 123 to the multiplexer 125. The multiplexer 125 may then be connected via an optical path 128 to a 20 Km single mode optical fiber (SMF) 130, for example. The SMF 130 may be connected via an optical path 133 to a power splitter/combiner (power splitter) 135, which, in turn, may be connected to gigabit optical network units (GONU), represented as GONU 140 via an optical path 137 and GONU 145 via a different optical path 143.

Each GONU, as used in current practice, may contain a triplexer 146 with a filter to separate the different optical bands of wavelengths, such as C-, S-, and O-Band wavelengths. The triplexer 146 may be connected via an internal optical path 147 to a C-Band detector 148 connected via an electrical link 149 to a C-Band radio frequency receiver (C-Band RF RX) 150. The triplexer 146 may also be connected via an optical path 151 to an S-Band detector 152 connected via an electrical link 153 to an S-Band RX 154. The GONU 145 may also contain an O-Band TX 155 connected via an electrical link 156 to an O-Band laser source 157 connected via an optical path 158 to the triplexer 146.

Due to demand for bandwidth by consumers, there is a need in the communications industry to increase data rate in access networks. As service providers transition from video delivery to Internet Protocol Television (IPTV) and as high-definition television (HDTV) channels receive an upsurge in popularity, data rates supported in current broadband passive optical networks (BPON) or gigabit passive optical networks (GPON) may be insufficient to support the commercial demand. Due to the large capital investments made by service providers in the current BPON/GPON, a smooth and cost-effective transition to the next generation of network(s) is expected to be useful. Additionally, the next generation network(s) are unlikely to replace existing networks, so there is expected to be a period where next generation and legacy (i.e., existing) networks will coexist so that existing customers are not impacted.

An example embodiment of the invention is directed to a migration path from the currently deployed GPON networks to next generation networks that support advanced services along with the existing video overlay through the transition to a full wavelength division multiplexing network. The transition is transparent to existing GPON customers while providing a cost-effective method to upgrade the existing GPON customers. The upgraded passive optical network employed in accordance with an example embodiment of the invention may work within current Optical Distribution Network (ODN) constraints of a 28 dB budget in some optical networks.

The first upgrade may be in the form of adding another transmitter at the central office to carry new advanced services, such as multi-cast channels for IPTV. One example of a proposed wavelength according to an example embodiment of this invention for that transmitter is greater than 1600 nm, which is in the optical L-Band. This may enable service providers to employ a 45° beamsplitter and wavelength division multiplexing (WDM) blocking filters to provide enough isolation between this new wavelength and the GPON wavelengths. The new ONTs may receive the new wavelength through a new optical device that has photodiode for the L-Band and internal optical filters to provide enough isolation between the different bands. The resulting device is more of a quadplexer, where it has an L-Band RX, C-Band video RX, S-Band RX, and O-Band TX. ONTs already deployed in the field may be equipped with an in-line blocking filter so the traffic carried on the new wavelength does not interfere with the legacy services on other wavelengths.

An example embodiment of the invention provides a method, or corresponding apparatus, of upgrading existing optical networks. The method includes adding a supplemental optical communications band, normally used in optical transport networks to carry identical forms of data traffic as carried in other optical communications bands, to at least a subset of multiple existing optical access networks having at least one existing communications band. Over time, a radio frequency video overlay is removed from at least one of the existing optical communications bands in a subset of the multiple existing optical access networks. Multi-cast channels may be applied to the supplemental optical communications bands to carry forms of data traffic previously carried by the radio frequency overlay.

The supplemental optical communications band may be defined as at least a portion of the optical L-Band, and the other optical communications bands may be defined as at least a portion of at least two of the optical C-, O-, and S-Bands. The supplemental optical communications band and the other optical communications bands may be directing onto respective optical paths.

The method or corresponding apparatus may also include adding a wavelength in at least a portion of the optical C-Band or O-Band, transmitting at least one continuous wavelength optical signal in at least one respective subband of the optical C-Band or O-Band in a downstream direction, modulating the at least one continuous wavelength optical signal to produce a modulated optical signal, and directing the modulated optical signal in an upstream direction.

The method or corresponding apparatus may also include repurposing at least one erbium-doped fiber amplifier (EDFA) previously used to amplify optical signals carrying the radio frequency video overlay. The repurposing of the at least one EDFA may include amplifying digital optical signals to extend reach and density of the existing passive optical network or increasing a density of digital optical signals of the supplemental optical communications band.

The method or corresponding apparatus may also include applying data traffic for emerging services to the supplemental optical communications band.

Another example embodiment of the invention provides an optical receiver or corresponding method. The optical receiver includes a filter configured (i) to reflect a first optical signal traveling in a forward direction along a first optical path onto a second optical path and (ii) to pass a second optical signal traveling in a forward direction along the first optical path to a second optical path and, in a reverse direction, from the second optical path to the first optical path.

The optical receiver or corresponding method may also include an optical detector to detect the first optical signal and a reflective semiconductor optical amplifier (RSOA) configured to modulate the second optical signal and direct the second optical signal from the forward direction to the reverse direction in the second optical path. The RSOA may include an integrated photodiode and may be configured to be a pluggable device.

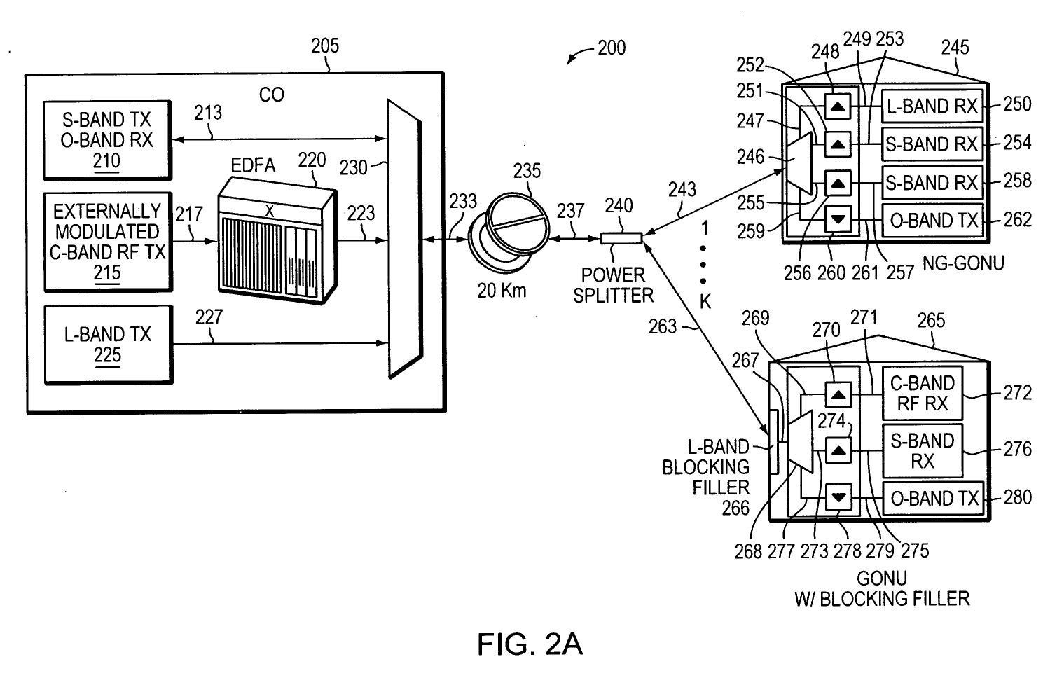

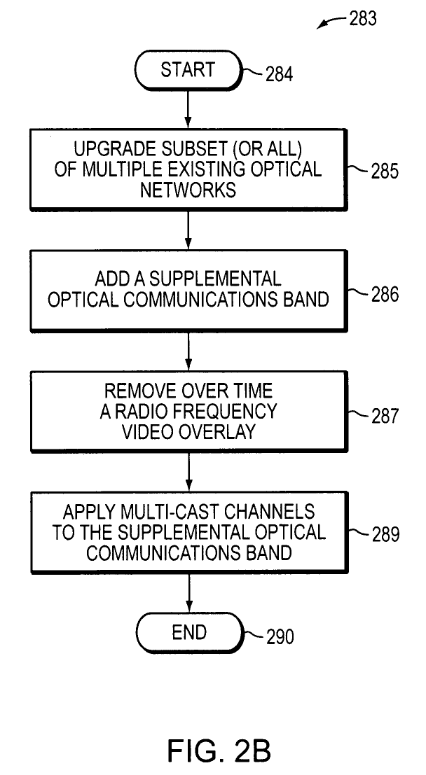

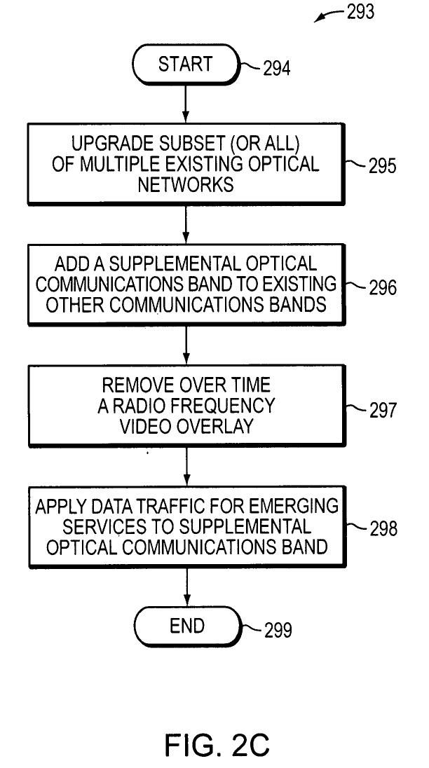

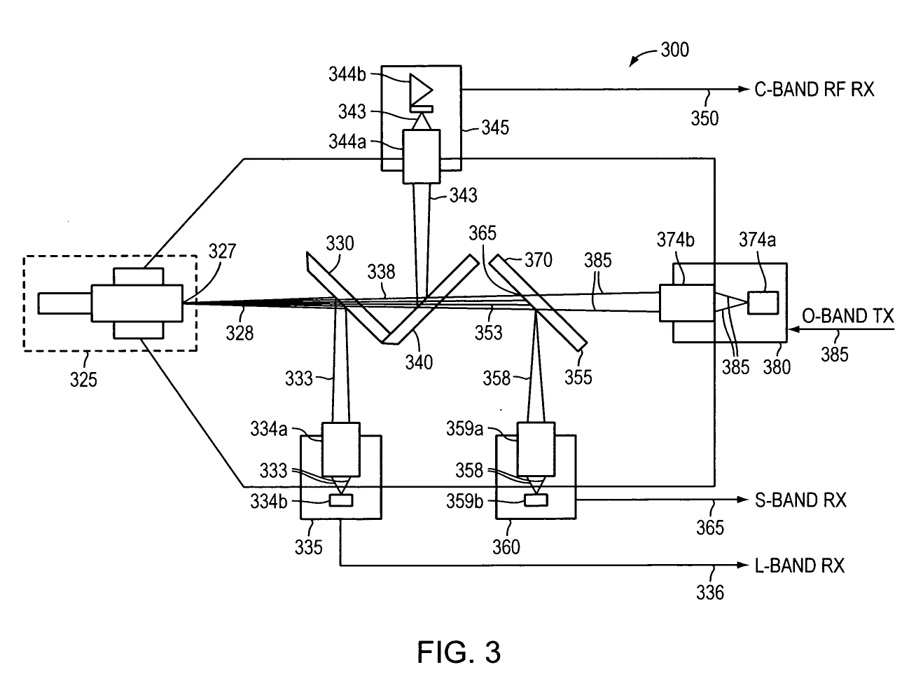

FIG. 2 illustrates a GPON-VO 200 as used in accordance with an example embodiment of the invention. The central office (CO) 205 may include: a subsystem 210 with an S-Band TX and an O-Band RX, EMCT 215, L-Band TX 225, EDFA 220, and multiplexer 230. The subsystem 210, EMCT 215, EDFA 220, and multiplexer 230 may be connected as illustrated in FIG. 1. The L-Band TX 225 of FIG. 2 may also be connected via an optical path 227 to the multiplexer 230. The L-Band may be used because it is least intrusive and useful because separation into subbands is easy. For example, a 45° optical filter in an optical receiver (discussed below in reference to FIG. 3) may be used based upon separation, and expenses may be reduced because to separate the optical L-Band from other bands may not require additional coating of a filter. The multiplexer 230 may be connected via an optical path 233 to a 20 Km SMF 235, which may be connected via an optical path 237 to a power splitter 240. The power splitter may be connected to a next generation GONU (NG-GONU) 245 and a legacy GONU 265.

The NG-GONU 245 may contain a quadplexer 246, L-Band detector 248 and L-Band RX 250, C-Band detector 252 and C-Band RF RX 254, S-Band detector 256 and S-Band RX 258, and O-Band detector 260 and O-Band TX 262. The power splitter 240 may be connected via an optical path 243 to the quadplexer 246, which, in turn, may be connected to detectors and a laser source for the bands, as applicable (L-Band detector 248 by an optical path 247, C-Band detector 252 by an optical path 251, S-Band detector 256 by an optical path 255, and O-Band laser source 260 by an optical fiber 259). Each detector 248, 252, 256 may then be connected to its respective receiver: L-Band RX 250 by electrical link 249, C-Band RF RX 254 by an electrical link 253; and S-Band RX 258 by an electrical link 257. The O-Band laser source 260 may be connected via an electrical link 261 to an O-Band TX 262.

For each existing customer, an L-Band blocking filter 266 may be added to the GONU 265 to allow for changing and upgrading other GONUs 245 in a manner that may be transparent to a current user. The power splitter 240 may be connected via an optical path 263 to the L-Band blocking filter 266. Optical signals (not shown) destined for receivers in the GONU 265 may then be transmitted via an optical path 267 to a triplexer 268. The triplexer 268 may be connected to a detector for each band: C-Band detector 270 connected by an optical path 269, S-Band detector 274 connected by an optical path 273, and O-Band laser source 278 connected by an optical path 277. The detectors and laser source may then be connected to respective receivers or transmitter: C-Band RF RX 272 connected by an electrical link 271, S-Band RX 276 connected by an electrical link 275, and O-Band TX 280 connected by an electrical link 279.

FIG. 2B is a first of two flow diagrams 283 illustrating upgrading existing optical networks in accordance with example embodiments of the present invention. After the process is initiated (284), a subset (or all) of the multiple existing optical networks may be upgraded (285), which may include adding a supplemental optical communications band (286). Next, over a period of time, radio frequency video overlay may be removed (287) from the existing optical networks. Then, multi-cast channels may be applied (289) to the supplemental optical communications band. Upon applying the multi-cast channels, the upgrading process terminates (290).

FIG. 2C is a second of two flow diagrams 293 of upgrading existing optical networks in accordance with example embodiments of the present invention. After the process is initiated (294), a subset (or all) of the multiple existing optical networks may be upgraded (295), which may include adding a supplemental optical communications band to existing other communications bands (296). Next, over a period of time, radio frequency video overlay may be removed (297) from the existing optical networks. Then, data traffic for emerging services may be applied (298) to the supplemental optical communications band. Upon applying the multi-cast channels, the upgrading process terminates (299).

FIG. 3 is a diagram of the optical design of an example quadplexer 300 in accordance with an example embodiment of the present invention. The quadplexer 300, which corresponds to the quadplexer 247 of FIG. 2 and may be the same or different in design or construction, includes units (e.g., O-Band unit 380, L-Band unit 335, C-Band unit 345, S-Band unit 360) configured for each band transmitted within a passive optical network in which the example embodiment of the present invention is deployed. As described in detail immediately below, each unit may be configured to receive and transmit its respective band to a corresponding receiver.

Continuing to refer to FIG. 3, an optical input/output port 325 permits the optical signals 327 to enter the quadplexer 300. As the optical signals 327 travel through the quadplexer 300, the optical signals 327 encounter a series of filters (L-Band filter 330, C-Band RF filter 340, S-Band filter 355, and O-Band filter 370). As the optical signals 327 reach each filter, the appropriate wavelength for each band is filtered. For example, L-Band wavelength 328 is reflected by the L-Band filter 330 and emerges from the optical signals 327 as an L-Band filtered wavelength 333 received by an L-Band lens 334a, then an L-Band opto-electronic chip 334b used to convert optical signals to a corresponding electrical signal. Similar filtering occurs for the C-, S-, and O-Bands: C-Band wavelength 338, C-Band filter 340, C-Band filtered wavelength 343, C-Band preamplifier 344a, C-band amplifier 344b; S-Band wavelength 353, S-Band filter 355, S-Band filtered wavelength 358, S-Band lens 359a, S-Band opto-electronic chip 359b; O-Band wavelength 305, O-Band filter 370, O-Band filtered wavelength 365, O-Band lens 374b, O-Band opto-electronic chip 374a). Each unit contained within the quadplexer 300 may be configured to receive optical signals and direct electrical signals to the appropriate receiver. For example, the L-Band unit 335 directs the L-Band electrical signal 336 to the L-Band receiver 250 (see FIG. 2); the C-Band unit 345 directs the C-Band electrical signal 350 to the C-Band receiver 254 (see FIG. 2); the S-Band unit 360 directs the S-Band electrical signal 365 to the S-Band receiver 258 (see FIG. 2); and the O-Band unit 380 directs the O-Band optical signal 385 to the O-Band receiver 210 (see FIG. 2) via the input/output port 325.

The second upgrade may be in the form of upgrading the entire network into a full coarse or dense WDM (CWDM/DWDM) network. To do so, the power splitters in the field are replaced with array waveguide modules, and a reflective device is installed at each ONT to make it wavelength-agnostic. An integrated photodiode, filter, and reflective semiconductor optical amplifier (RSOA) may be employed as a diplexer. The new WDM-PON network may be overlaid over the already-deployed time division multiplexing (TDM) GPON network without impacting any of the legacy services. The EDFAs, currently used for video overlay, may be repurposed to increase the C-band CWDM/DWDM signals to overcome the ODN 28 dB budget or extend optical transmission distances beyond 20 Km.

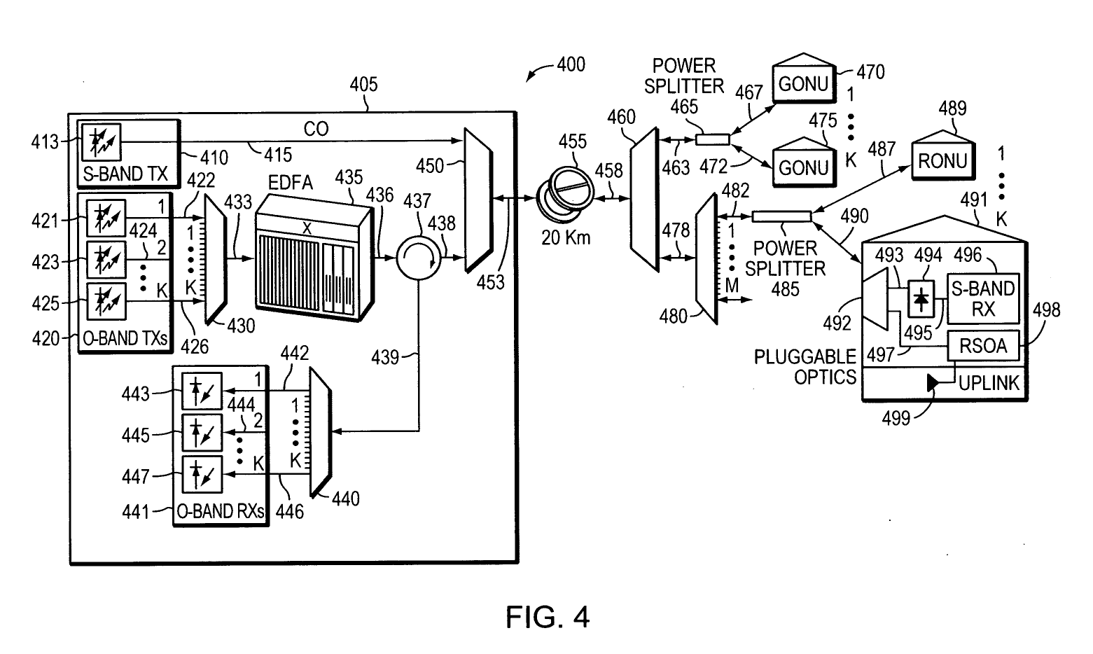

FIG. 4 is a schematic diagram of a WDM PON 400 in accordance with another embodiment of the present invention. The CO 405 may contain an S-Band TX 413, O-Band TXs 420 (represented herein as the O-Band TX 421, 423, . . . , 425), first fine multiplexer 430, EDFA 435, circulator 437, second fine multiplexer 440, O-Band RXs 441 (represented as the O-Band RX 443, 445, . . . , 447), and first (near end) coarse multiplexer 450. It should be understood that the naming convention “coarse” and “fine” multiplexers as used herein refers to multiplexing “bands” and “subbands within a band,” respectively.

The S-Band TX 410 may be connected via an optical path 415 to the first coarse multiplexer 450. The O-Band TXs 420 may be connected via optical paths (422, 424, . . . , 426, respectively) to the first fine multiplexer 430, which may, in turn, be connected via an optical path 433 to the EDFAs 435. The EDFAs 435 transmit optically amplified signals via an optical path 436, circulator 437, and optical path 438 to the first coarse multiplexer 450. The circulator 437 returns optical signals from an optical path 438 to an optical path 439 to the second fine multiplexer (demultiplexer) 440. The first coarse multiplexer 450 is configured to multiplex the optical signals received from the S-Band TX 410 and the O-Band TX 420.

The first coarse multiplexer 450 is connected via the optical path 453 to a 20 Km SMF 455, which may then connect via an optical path 458 to a second (far end) coarse demultiplexer 460. The second coarse demultiplexer 460 may be connected via an optical path 463 to a power splitter 465 and GONUs 470, 475. The second coarse demultiplexer 460 may also be connected via an optical path 478 to a third fine demultiplexer 480. The third fine demultiplexer 480 may be connected via an optical path 482 to a power splitter 485, which may, in turn, be connected via optical paths 487 . . . 490 to reflective optical network units (RONUs) 489 . . . 491, respectively.

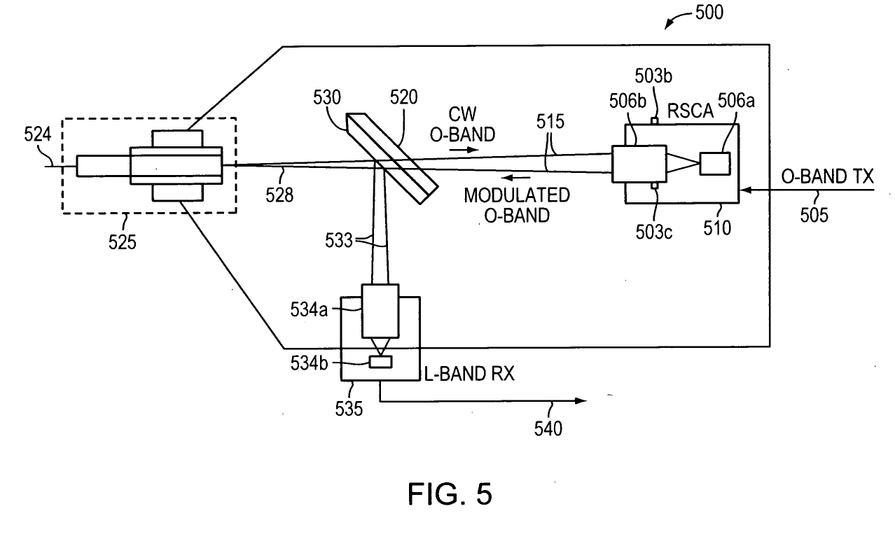

Each RONU may contain a diplexer 492 that may be connected to an S-Band RX 496 and a RSOA 498. In particular, in this example embodiment, the diplexer 492 may be connected via an electrical link 493 to an S-Band detector 494 that may be connected by an optical path 495 to the S-Band RX 496. The diplexer 492 may also be connected via an optical path 497 to the RSOA 490 (see FIG. 5), which may have an uplink connection 499.

FIG. 5 is a schematic diagram of components of an integrated RSOA-based diplexer 500 that may support cost-effective and transparent upgrading of a passive optical network in accordance with example embodiments of the present invention. An optical signal 524 may enter the integrated RSOA-based diplexer 500 via an input/output port 525, where optical signals in the L-Band 528 may travel to an L-Band unit 535 by reflection of an L-Band filter 530. An L-Band “filtered” signal 533 may reach the L-Band lens 534a, and then the L-Band opto-electronic chip 534b, by which the optical signal is converted to a corresponding electrical signal. The L-Band unit 535 may then transmit the corresponding L-Band electrical signal 540 to an L-Band RX (not shown).

Continuing to refer to FIG. 5, the RSOA 510 may receive an electrical (or optical) signal 505 and convert it by a light modulating chip (LMC) 506a with an integrated photodiode. The LMC has a reflective coating on the back facet that reflects and directs an amplified optical signal to its respective optical device. The LMC 506a modulates a continuous wave (CW) optical carrier signal, passed by an O-Band filter 520 in a downstream (i.e., forward) direction, with an optical signal corresponding to the electrical (or optical) signal 505 to produce a modulated O-Band signal. The LMC 506a directs the modulated O-Band optical signal to a coupling lens 506b, which further directs the modulated O-Band optical signal to the O-Band filter 520, which passes the O-Band optical signal to the input/output port 525 for upstream transmission (i.e., reverse direction) to the O-Band RXs 441 (see FIG. 4).

Based on the configuration illustrated in FIG. 5, an optical path to the left of the filters 530, 520 may be referred to herein as a first optical path, an optical path between the L-Band filter 530 and L-Band RX 535 may be referred to herein as a second optical path, and an optical path between the O-Band filter 520 and RSOA 510 may be referred to herein as a third optical path.

Further referring to FIG. 5, the RSOA may include mechanical connectors 503a and 503b (mating connection not shown) that allow the RSOA to be plugged and unplugged into and from a chassis that is configured with at least one other receiver (not shown). “Mechanical connectors” includes pin socket, screw fitting, or other mechanical connectors known in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method of upgrading existing optical networks, comprising:
adding a supplemental optical communications band, normally used in optical transport networks to carry identical forms of data traffic as carried in other optical communications bands, to at least a subset of multiple existing optical access networks having at least one existing communications band;
removing over time, from subsets of the multiple existing optical access networks, a radio frequency video overlay in at least one of the existing optical communications bands in the subsets of multiple optical access networks; and
applying multi-cast channels to the supplemental optical communications band to carry forms of data traffic previously carried by the radio frequency video overlay.

2. The method as claimed in claim 1 wherein the supplemental optical communications band is defined as at least a portion of the optical L-Band.

3. The method as claimed in claim 2 wherein the other optical communications bands are defined as at least a portion of at least two of the optical C-, O-, and S-Bands.

4. The method as claimed in claim 1 further including directing the supplemental optical communications band and the other optical communications bands onto respective optical paths.

5. The method as claimed in claim 1 further including:
adding at least a portion of the optical O-Band;
transmitting at least one continuous wavelength optical signal in at least one respective subband of the optical O-Band in a downstream direction;
modulating the at least one continuous wavelength optical signal to produce a modulated optical signal; and
directing the modulated optical signal in an upstream direction.

6. The method as claimed in claim 5 further including adding at least one respective subband in the optical C-Band.

7. The method as claimed in claim 1 wherein upgrading the subset of multiple existing optical networks includes repurposing at least one erbium-doped fiber amplifier (EDFA) previously used to amplify optical signals carrying the radio frequency video overlay.

8. The method as claimed in claim 7 wherein repurposing the at least one EDFA includes amplifying digital optical signals to extend reach and density of the existing passive optical network or increasing a density of digital optical signals of the supplemental optical communications band.

9. The method as claimed in claim 1 further including applying data traffic for emerging services to the supplemental optical communications band.

10. An apparatus to upgrade existing passive optical networks, the apparatus comprising:
a first optical transmitter configured to transmit first optical signals in a first optical communications band modulated with radio frequency overlay to at least one downstream destination in the passive optical network; and
a second optical transmitter configured to transmit second optical signals in a second optical communications band, normally used in transport networks to the carry identical forms of data traffic as carried in other communications bands in transport networks, to the at least one downstream destination in the passive optical access network with forms of data traffic previously carried by the radio frequency overlay.

11. The apparatus as claimed in claim 10 wherein the second optical signal band is at least a portion of the optical L-Band.

12. The apparatus as claimed in claim 10 further including a third optical transmitters configured to transmit a third optical signal in a third optical communications band and wherein the at least one downstream destination includes a quadplexer configured to separate the first, second, and third optical signals and direct them to receivers and further configured to direct a fourth optical signal in an upstream direction to an upstream destination.

13. The apparatus as claimed in claim 10 wherein at least one of the downstream destinations includes a blocking filter to prevent reception of the second optical signals.

14. The apparatus as claimed in claim 10 further including a receiver at the downstream destination configured to modulate a continuous wave optical signal and to produce a modulated optical signal and direct the modulated optical signal in an upstream direction.

15. The apparatus as claimed in claim 14 wherein the optical receiver includes a reflective semiconductor optical amplifier with an integrated photodiode.

16. The apparatus as claimed in claim 14 wherein the receiver is configured to be plugged and unplugged into and from a chassis configured with at least one other receiver.

17. The apparatus as claimed in claim 14 further including a third optical transmitter configured to transmit multiple continuous wavelength optical signals in respective subbands in a third optical communications band.

18. The apparatus as claimed in claim 17 wherein the respective subbands are within the optical O-Band.

19. An optical receiver, comprising:
a filter in an optical receiver configured to reflect a first optical signal traveling in a forward direction along a first optical path onto a second optical path and to pass to a second optical signal traveling in a forward direction along the first optical path to a third optical path and in a reverse direction from the third optical path to the first optical path.

20. The optical receiver as claimed in claim 19 further comprising:
an optical detector to detect the first optical signal; and
a reflective semiconductor optical amplifier (RSOA) configured to modulate the second optical signal and direct the second optical signal from the forward direction to the reverse direction in the third optical path.

21. The optical receiver as claimed in claim 19 wherein the RSOA includes an integrated photodiode.

22. The optical receiver as claimed in claim 19 wherein the RSOA is configured to be a pluggable device.

23. A method for receiving optical signals comprising:
reflecting a first optical signal traveling in a forward direction along a first optical path onto a second optical path; and
passing a second optical signal traveling in a forward direction along the first optical path to a third optical path and in a reverse direction from the third optical path to the first optical path.

24. The method as claimed in claim 23 further including:
detecting the first optical signal traveling; and
modulating the second optical signal and directing the second optical signal from the forward direction to the reverse direction in the third optical path.

25. The method as claimed in claim 24 wherein modulating the second optical receiver includes controlling an electro-optic device to modulate the second optical signal.

26. The method as claimed in claim 23 wherein further including activating the detecting of the first optical signal and modulating of the second optical signal in a plugged-in state and deactivating the detecting and modulating in an unplugged state.
